(19) United States
(12) Patent Application Publication
(10) Pub. No.: US 2017/0344363 A1
(43) Pub. Date: Nov. 30, 2017

(54) DEPENDENCY MANAGEMENT

(71) Applicant: LinkedIn Corporation, Mountain View, CA (US)

(72) Inventors: Wei Chen, Fremont, CA (US); Deeptendu Majumder, San Jose, CA (US); Jens Pillgram-Larsen, Pleasanton, CA (US)

(21) Appl. No.: 15/165,500

(22) Filed: May 26, 2016

(51) Int. Cl. G06F 9/44; G06F 17/30

(52) U.S. Cl. CPC G06F 8/70; G06F 17/30958

(57) ABSTRACT

Aspects of the present disclosure relate to dependency management. A server accesses an artifact repository, with the artifact repository storing information representing a built module. The server determines, using the information representing the built module, one or more dependee modules with which the built module has dependencies. The server stores, in a graph database, a representation of dependencies between the built module and the one or more dependee modules.

### RELATED APPLICATION

This application is related to US Patent Application Publication No. 2015/0227363, filed Feb. 13, 2014, and entitled, “SYSTEMS AND METHODS FOR SOFTWARE DEPENDENCY MANAGEMENT,” the entire content of which is incorporated herein by reference.

### TECHNICAL FIELD

The subject matter disclosed herein relates generally to software architecture. In particular, example embodiments may relate to dependency management.

### BACKGROUND

As software systems become larger and larger, more and more dependencies (e.g., when one software module uses code from another software module or library) are created. Keeping track of the dependencies is useful, for example, when libraries or modules that are used by other software are updated or bugs are discovered or fixed. Accordingly, techniques for managing dependencies within a software system may be desirable.

### SUMMARY

In one innovative aspect, the disclosed subject matter can be embodied in a method. The method includes accessing an artifact repository, the artifact repository storing information representing a built module. The method includes determining, using the information representing the built module, one or more dependee modules on which the built module has dependencies. The method includes storing, in a graph database, a representation of dependencies between the built module and the one or more dependee modules.

In one innovative aspect, the disclosed subject matter can be embodied in a non-transitory computer-readable medium including instructions. The instructions include code for accessing an artifact repository, the artifact repository storing information representing a built module. The instructions include code for determining, using the information representing the built module, one or more dependee modules with which the built module has dependencies. The instructions include code for storing, in a graph database, a representation of dependencies between the built module and the one or more dependee modules.

In one innovative aspect, the disclosed subject matter can be embodied in a system. The system includes one or more processors and a memory. The memory includes instructions. The instructions include code for accessing an artifact repository, the artifact repository storing information representing a built module. The instructions include code for determining, using the information representing the built module, one or more dependee modules with which the built module has dependencies. The instructions include code for storing, in a graph database, a representation of dependencies between the built module and the one or more dependee modules.

### BRIEF DESCRIPTION OF THE DRAWINGS

Various ones of the appended drawings merely illustrate example embodiments of the present inventive subject matter and cannot be considered as limiting its scope.

FIG. 1 is a diagram of an example system in which dependency management may be implemented.

FIG. 2 illustrates an example of a dependency graph.

FIG. 3 is a flowchart illustrating an example method for storing representations of dependencies.

FIG. 4 conceptually illustrates an example electronic system with which some implementations of the subject technology can be implemented.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

As noted above, techniques for managing dependencies within a software system may be desirable. In some software systems, if a module A uses a library B, A knows (based on its code) that it uses B. However, B does not know that it is used by A. Therefore, if B is updated, for example, to improve performance or to fix a bug, B has no way to notify A of the update. Some implementations of the subject technology provide techniques for managing dependencies within a software system, such that the library B can determine that it is being used by the module A.

According to some implementations, a dependency management server listens for an event corresponding to building a built module. Upon occurrence of the event, the dependency management sever accesses an artifact repository that stores information representing the built module and its dependencies. The dependency management server determines dependee module(s) with which the built module has dependencies. The dependency management server stores, in a graph database or other data repository, a representation of the dependencies between the built module and the dependee module(s). As used herein, the terms “build,” “building,” and “built module,” encompass their plain and ordinary meaning. In some cases, building a module refers to the process of converting source code of the module into standalone software artifact(s) that can be run on a computer, or the result of doing so.

The graph database stores a two-way graph/mapping of dependencies. In other words, the graph database stores both (i) representations that a given built module uses code from a dependee module, and (ii) representations that the code from a given module is used in a built dependent module. By accessing the graph database, a user or a machine can determine a set of built modules that depend on a certain other built module or a set of built modules that are depended upon by a given built module.

The graph database can be used for multiple different purposes. In some examples, when one of the dependee module(s) is updated or a bug in one of the dependee module(s) is discovered, a developer of the built dependent module is notified to adjust the code of the built module accordingly. In some examples, when one of the dependee modules is updated, the graph database is used to track how fast the update is propagated into the code of the built dependent module (e.g., by a programmer of the built module).

As used herein, the term “module” encompasses its plain and ordinary meaning. In addition, a module may include any block of software code, such as a software product, a software deployable, or a software library. A module may be identified, for example, by a name, a deployable artifact, and a version number.

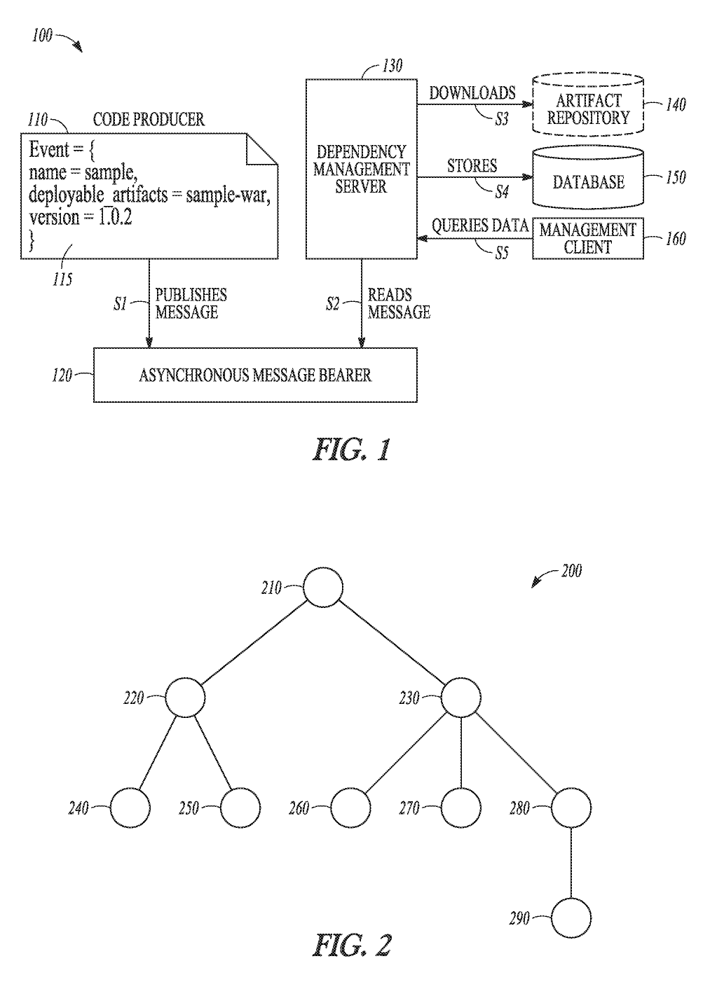

FIG. 1 is a diagram of an example system 100 in which dependency management may be implemented. As shown, the system 100 includes a code producer 110, an asynchronous message bearer 120, a dependency management server 130, an artifact repository 140, a database 150, and a management client 160. Steps S1-S5 are implemented by the machines 110-160 of the system.

The code producer 110 produces a module, which includes software code, to be built. Upon building the module, the code producer 110 publishes a message in step S1. The message is logged by the asynchronous message bearer 120. In some cases, the message includes the event 115, which indicates a name, deployable artifacts, and a version associated with a module that was built at the code producer 110.

In step S2, when the dependency management server 130 has processing capability, the dependency management server 130 reads the message from the asynchronous message bearer 120. The asynchronous message bearer 120 is implemented as a machine that stores messages (e.g., a server with a storage unit or a data repository). The messages can be read by any machine having access to the asynchronous message bearer 120, such as the dependency management server 130, at any time. For example, the dependency management server 130 reads messages from the asynchronous message bearer 120 when it has bandwidth. Upon reading the message, the dependency management server 130 learns that a new built module was built. According to some implementations, the dependency management server 130 subscribes to messages from the asynchronous message bearer 220, and consumes the message(s) after the message(s) are released and when the dependency management server 130 has processing capability. As a result, messages are processed when the dependency management server 130 has capability to process them, and the chance of the dependency management server 130 being bottlenecked due to a large number of messages is reduced. In some examples, one purpose of the asynchronous message bearer 120 is to notify the dependency management server 130 that a new built module is available, and that the dependency management server 130 should access the artifact repository 140 in order to add information about the new built module to the database 150, as described below.

In step S3, the dependency management server 130 downloads, from the artifact repository 140, information about the built module and its dependencies, which is stored in the artifact repository 140. In some aspects, upon building a module, information about the build is stored in the artifact repository 140 by the code producer 110, and this information is accessible to the dependency management server 130. In some cases, the information downloaded by the dependency management server 130 from the artifact repository 140 includes manifest files associated with the building of the built module, which specify its dependencies.

In step S4, the dependency management server 130 stores the information about the built module and its dependencies in the database 150. In some examples, the database 150 is implemented as a graph database that stores two-way representations of the dependencies. In other words, the database 150 can be used to determine what libraries are used by a given deployable, and which deployable(s) or product(s) use a given library. The dependency management server 130 modifies the data received from the artifact repository 140 to include the two-way representations of the dependencies before storing in the database 150. In some cases, step S4 includes the dependency management server gathering the dependency information from the manifest files (obtained from the artifact repository in step S3) and storing that dependency information in the database 150.

The database 150 is described herein as being a database (for example, a graph database). However, the database 150 may be any type of database, for example a SQL database or any other database. In some cases, a data repository that is not a database may be used in place of the database 150 and may store the same information as the database 150.

In step S5, the management client 160 queries data from the dependency management server 130. In some examples, the management client 160 is an end-user machine, such as a laptop computer, a desktop computer, a mobile phone, a tablet computer, or the like. The management client 160 queries data from the dependency management server 130, for example, to determine which module(s) use code from a library that has been changed or in which a bug has been discovered, or to determine whether an old version of a library that has been updated is still being used by any module(s). In some cases, the management client 160 queries data from the dependency management server using one or more application programming interfaces (APIs).

In some implementations, the subject technology avoids direct communication from the code producer 110 to the dependency management server 130. The asynchronous message bearer 120 allows the dependency management server 130 to access messages (e.g., from the code producer 110) when the dependency management server 130 has processing bandwidth. As a result, the subject technology is scalable in large software architectures, where thousands or millions of messages may need to be processed by the dependency management server 130.

In some implementations, the asynchronous message bearer 120 generates a message queue for the dependency management server 130. As a result, messages are processed by the dependency management server 130 in chronological order, preventing the database 150 from storing information representing that one module has a dependency with another module that has not yet been created in the database 150.

In FIG. 1, the machines 110-160 are illustrated as being separate and distinct machines. However, in some examples, each machine 110-160 may be implemented as multiple machines (e.g., a server farm). In some examples, a single machine may implement the functions of two or more of the machines 110-160. Furthermore, each of the machines 110-160 may be implemented as a physical machine, a virtual machine, or a combination of physical and virtual resources.

FIG. 2 illustrates an example of a dependency graph 200. As shown, the dependency graph 200 includes modules 210-290. Each module 210-290 is a product, a deployable, a library, or any other module. In some implementations, each module 210-290 is a software module.

As shown in FIG. 2, the module 210 has dependencies with (or uses code from) modules 220 and 230. The module 220 has dependencies with modules 240 and 250. The module 230 has dependencies with modules 260, 270, and 280. The module 280 has a dependency with module 290.

In some implementations, the dependency graph 200 is stored in the database 150. The graph 200 is useful, for example, in updating or debugging software. For example, if a bug is found in module 240, the authors or programmers of modules 220 and 210, which use module 240, may need to be notified. If an update is made to module 290, the update may be propagated to modules 280, 230, and 210, which use module 290. If an update is made to module 230, the update may be propagated to module 210. In some cases, the update may also be relevant to the authors or programmers of modules 260, 270, 280, and 290, as the update shows changes to how their code is used, and their code may be optimized based on the updates. If a new version of code in one of the modules 220-290 is created, the graph 200 is useful in determining how fast the update is propagated to other modules, and how quickly the changed code becomes used.

The dependency graph 200 illustrates dependencies between deployable modules and library modules. This may be a subset of a more generalized graph that captures dependencies between a broader range of modules. In some aspects, a two-level graph uses the compositional semantics, i.e., deployable X contains libraries Y and Z, which is derived from dependency semantics, i.e., X depends on Y and Z.

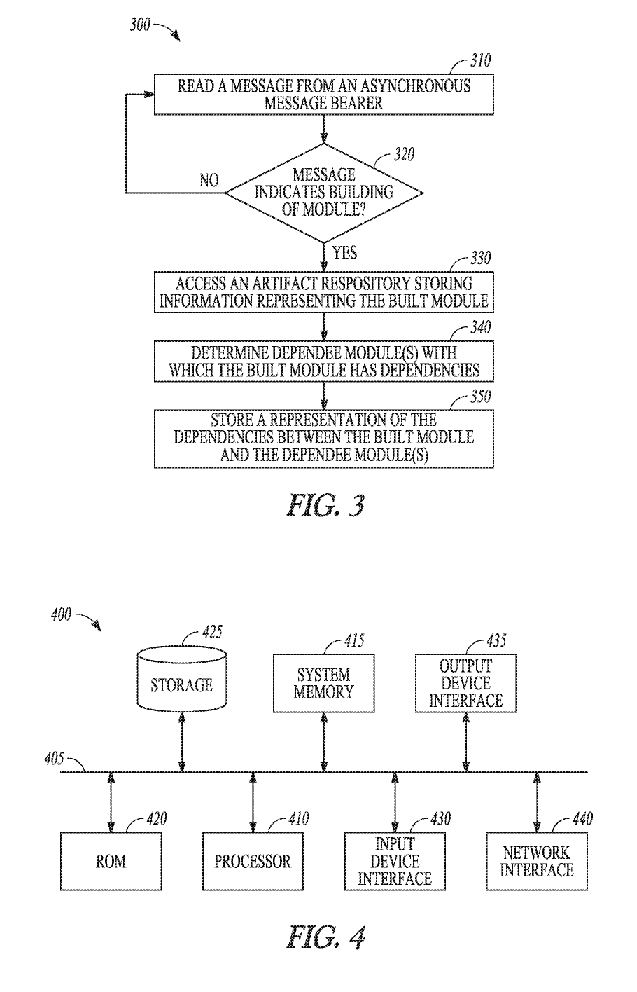

FIG. 3 is a flowchart illustrating a method 300 for storing representations of dependencies. In some examples, the method 300 is implemented at the dependency management server 130 of FIG. 1.

The method 300 begins at step 310, where the dependency management server 130 reads a message from the asynchronous message bearer 120. In some cases, the message is generated, by the asynchronous message bearer 120, in response to the event 115, from the code producer 110, indicating or corresponding to building of a module. In some implementations, the reading of the message is asynchronous with the event (e.g., building the module) for generating the message. The message is stored at the asynchronous message bearer 120 from when the message is generated until the message is read by the dependency management server 130, or until a time later than when the message is read by the dependency management server 130.

At step 320, the dependency management server 130 determines whether the message indicates the building of the module. In some implementations, the asynchronous message bearer stores messages indicating building of modules and other messages provided to the dependency management server (e.g., reset or reboot requests). If the message indicates the building of the module, the method 300 continues to step 330. Otherwise, the method 300 returns to step 310.

At step 330, upon determining that the message indicates the building of the module, the dependency management server 130 accesses the artifact repository 140. The artifact repository 140 stores information representing the built module. For example, the artifact repository 140 stores information representing dependencies of the built module (other modules from which the built module uses code).

At step 340, the dependency management server 130 determines dependee module(s) with which the built module has dependencies. Put another way, the dependency management server 130 determines dependee module(s) that have dependencies with the build module. The dependee module(s) are determined using the information representing the built module accessed from the artifact repository 140. According to some implementations, the built module is a product or a deployable, and the dependee module(s) are libraries used by the built module.

At step 350, the dependency management server 130 stores a representation of the dependencies between the built module and the dependee module(s). In some aspects, the representation of the dependencies is stored in the database 150, which is, for example, a graph database. The graph is created by the dependency management server 130 storing two-way representations of the dependencies in the database 150. Within the database 150, modules, such as libraries, deployables, and products, are represented using one or more of a name value, an organization value, a revision value, and a configuration value. The database 150 stores a two-way representation of dependencies. In other words, the database 150 can be used to determine both which libraries a given product uses and which products use a given library.

Various use cases are possible for the data stored in the database 150. In one example, the management client 160 can determine that a bug exists in a first dependee module from among the dependee module(s) of the built module. The management client 160 can query the dependency management server 130 for built module(s) that use the first dependee module, and notify (e.g., via email) author(s) or programmer(s) of the built module(s) of the bug in the first dependee module.

In another example, the dependency management server 130 receives a representation of a change to the first dependee module from among the dependee module(s) of the built module. The dependency management server 130 notifies (e.g., via email) the author of the built module of the change to the first dependee module. The dependency management server 130 tracks an amount of time until the built module is updated based on the change to the first dependee module. The update includes, for example, accessing the new version of the first dependee module. After step 350, the method 300 ends.

FIG. 4 conceptually illustrates an electronic system 400 with which some implementations of the subject technology are implemented. For example, one or more of the code producer 110, the asynchronous message bearer 120, the dependency management server 130, the artifact repository 140, the database 150, or the management client 160 may be implemented using the arrangement of the electronic system 400. The electronic system 400 can be a computer (e.g., a mobile phone, personal digital assistant) or any other sort of electronic device. Such an electronic system includes various types of computer readable media and interfaces for various other types of computer readable media. Electronic system 400 includes a bus 405, processor(s) 410, a system memory 415, a read-only memory (ROM) 420, a permanent storage device 425, an input device interface 430, an output device interface 435, and a network interface 440.

The bus 405 collectively represents all system, peripheral, and chipset buses that communicatively connect the numerous internal devices of the electronic system 400. For instance, the bus 405 communicatively connects the processor(s) 410 with the read-only memory 420, the system memory 415, and the permanent storage device 425.

From these various memory units, the processor(s) 410 retrieves instructions to execute and data to process in order to execute the processes of the subject technology. The processor(s) can include a single processor or a multi-core processor in different implementations.

The ROM 420 stores static data and instructions that are needed by the processor(s) 410 and other modules of the electronic system. The permanent storage device 425, on the other hand, is a read-and-write memory device. This device is a non-volatile memory unit that stores instructions and data even when the electronic system 400 is off. Some implementations of the subject technology use a mass-storage device (for example, a magnetic or optical disk and its corresponding disk drive) as the permanent storage device 425.

Other implementations use a removable storage device (for example a floppy disk, flash disk, and the corresponding disk drive) as the permanent storage device 425. Like the permanent storage device 425, the system memory 415 is a read-and-write memory device. However, unlike storage device 425, the system memory 415 is a volatile read-and-write memory, such as a random access memory (RAM). The system memory 415 stores some of the instructions and data that the processor needs at runtime. In some implementations, the processes of the subject technology are stored in the system memory 415, the permanent storage device 425, or the read-only memory 420. For example, the various memory units include instructions for dependency management in accordance with some implementations. From these various memory units, the processor(s) 410 retrieves instructions to execute and data to process in order to execute the processes of some implementations.

The bus 405 also connects to the input and output device interfaces 430 and 435. The input device interface 430 enables the user to communicate information and select commands to the electronic system. Input devices used with input device interface 430 include, for example, alphanumeric keyboards and pointing devices (also called “cursor control devices”). Output device interface 435 enables, for example, the display of images generated by the electronic system 400. Output devices used with output device interface 435 include, for example, printers and display devices (for example, cathode ray tubes (CRT) or liquid crystal displays (LCD)). Some implementations include devices that function as both input and output devices (for example, a touch screen).

Finally, as shown in FIG. 4, bus 405 also couples electronic system 400 to a network (not shown) through a network interface 440. In this manner, the electronic system 400 can be a part of a network of computers (for example, a local area network (LAN), a wide area network (WAN), or an Intranet) or a network of networks (for example, the Internet). Any or all components of electronic system 400 can be used in conjunction with the subject technology.

The above-described features and applications can be implemented as software processes that are specified as a set of instructions recorded on a computer readable storage medium (also referred to as computer readable medium). When these instructions are executed by one or more processor(s) (which may include, for example, one or more processors, cores of processors, or other processing units), they cause the processor(s) to perform the actions indicated in the instructions. Examples of computer readable media include, but are not limited to, compact disk read-only memories (CD-ROMs), flash drives, RAM chips, hard drives, erasable programmable read only memories (EPROMs), and the like. The computer readable media does not include carrier waves and electronic signals passing wirelessly or over wired connections.

In this specification, the term “software” is meant to include firmware residing in ROM or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage, and memory, that store computer program instructions in a machine-readable or computer-readable medium (alternatively referred to as computer-readable storage media, machine-readable media, or machine-readable storage media). Some examples of such computer-readable media include RAM, ROM, CD-ROM, recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., secure digital (SD) cards, mini-SD cards, micro-SD cards, etc.), magnetic or solid state hard drives, read-only and recordable Blu-Ray® discs, ultra-density optical discs, any other optical or magnetic media, and floppy disks. The computer-readable media can store a computer program that is executable by at least one processor and includes sets of instructions for performing various operations. Examples of computer programs or computer code include machine code, for example, produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer,” “server,” “processor,” and “memory” all refer to electronic or other technological devices. These terms exclude people or groups of people. For the purposes of the specification, the terms display or displaying mean displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT or LCD monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user (for example, by sending web pages to a web browser on a user's client computing device in response to requests received from the web browser).

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a LAN and a WAN, an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., a hypertext markup language (HTML) page) to a client computing device (e.g., for purposes of displaying data to and receiving user input from a user interacting with the client computing device). Data generated at the client computing device (e.g., a result of the user interaction) can be received from the client computing device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but are to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect,” does not imply that the aspect is essential to the subject technology or that the aspect applies to all configurations of the subject technology. A disclosure relating to an aspect may apply to all configurations, or one or more configurations. A phrase, for example, an aspect, may refer to one or more aspects and vice versa. A phrase, for example, a “configuration,” does not imply that such configuration is essential to the subject technology or that such configuration applies to all configurations of the subject technology. A disclosure relating to a configuration may apply to all configurations, or one or more configurations. A phrase, for example, a configuration, may refer to one or more configurations and vice versa.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

In this document, the terms “a” or “an” are used, as is common in patent documents, to include one or more than one, independent of any other instances or usages of “at least one” or “one or more.” In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” “third,” and so forth are used merely as labels, and are not intended to impose numerical requirements on their objects.

1. A method comprising:
accessing an artifact repository, the artifact repository storing information representing a built module;
determining, using the information representing the built module, one or more dependee modules having dependencies with the built module;
storing, in a graph database, a representation of dependencies between the built module and the one or more dependee modules;
determining that a bug exists in a first dependee module from among the one or more dependee modules; and
notifying, based on information stored in the graph database, an author of the built module of the bug existing in the first dependee module.

2. The method of claim 1, further comprising:
reading a message indicating building of the built module, wherein accessing the artifact repository is asynchronous with an event corresponding to building of the built module and is responsive to reading the message indicating building of the built module.

3. The method of claim 2, wherein the message is generated by an asynchronous message bearer in response to the event corresponding to building of the built module, wherein the asynchronous message bearer is different from a code producer machine that builds the built module.

4. The method of claim 1, wherein the one or more dependee modules comprise one or more libraries; and
wherein the built module comprises a product or a deployable.

5. The method of claim 4, wherein each library is represented, in the graph database, by one or more of a name value, an organization value, a revision value, and a configuration value.

6. (canceled)

7. The method of claim 1, further comprising:
receiving a representation of a change to a first dependee module from among the one or more dependee modules;
notifying an author of the built module of the change to the first dependee module; and
tracking an amount of time until the built module is updated based on the change to the first dependee module.

8. The method of claim 1, wherein the representation of the dependencies between the built module and the one or more dependee modules, stored in the graph database, comprises a two-way representation of the dependencies.

9. A non-transitory machine-readable medium comprising instructions which, when executed by one or more processors of a machine, cause the machine to perform operations comprising:
accessing an artifact repository, the artifact repository storing information representing a built module;
determining, using the information representing the built module, one or more dependee modules having dependencies with the built module;
storing, in a graph database, a representation of dependencies between the built module and the one or more dependee modules;
determining that a bug exists in a first dependee module from among the one or more dependee modules; and
notifying, based on information stored in the graph database, an author of the built module of the bug existing in the first dependee module.

10. The machine-readable medium of claim 9, the operations further comprising:
reading a message indicating building of the built module, wherein accessing the artifact repository is asynchronous with an event corresponding to building of the built module and is responsive to reading the message indicating building of the built module.

11. The machine-readable medium of claim 10, wherein the message is generated by an asynchronous message bearer in response to the event corresponding to building of the built module, wherein the asynchronous message bearer is different from a code producer machine that builds the built module.

12. The machine-readable medium of claim 9, wherein the one or more dependee modules comprise one or more libraries; and
wherein the built module comprises a product or a deployable.

13. The machine-readable medium of claim 12, wherein each library is represented, in the graph database, by one or more of a name value, an organization value, a revision value, and a configuration value.

14. (canceled)

15. The machine-readable medium of claim 9, the operations further comprising:
receiving a representation of a change to a first dependee module from among the one or more dependee modules;
notifying an author of the built module of the change to the first dependee module; and
tracking an amount of time until the built module is updated based on the change to the first dependee module.

16. The machine-readable medium of claim 9, wherein the representation of the dependencies between the built module and the one or more dependee modules, stored in the graph database, comprises a two-way representation of the dependencies.

17. A system comprising:
one or more hardware processors; and
a memory comprising instructions which, when executed by the one or more hardware processors, cause the one or more processors to perform operations comprising:
accessing an artifact repository, the artifact repository storing information representing a built module;
determining, using the information representing the built module, one or more dependee modules having dependencies with the built module;
storing, in a graph database, a representation of dependencies between the built module and the one or more dependee modules;
determining that a bug exists in a first dependee module from among the one or more dependee modules; and
notifying, based on information stored in the graph database, an author of the built module of the bug existing in the first dependee module.

18. The system of claim 17, the operations further comprising:
reading a message indicating building of the built module, wherein accessing the artifact repository is asynchronous with an event corresponding to building of the built module and is responsive to reading the message indicating building of the built module.

19. The system of claim 18, wherein the message is generated by an asynchronous message bearer in response to the event corresponding to building of the built module, wherein the asynchronous message bearer is different from a code producer machine that builds the built module.

20. The system of claim 17, wherein the one or more dependee modules comprise one or more libraries; and
wherein the built module comprises a product or a deployable.
